(19) United States
(12) Patent Application Publication
(10) Pub. No.: US 2016/0087515 A1
(43) Pub. Date: Mar. 24, 2016

(54) LINEAR-ROTARY ACTUATOR

(71) Applicant: KABUSHIKI KAISHA YASKAWA DENKI, Kitakyushu-shi (JP)

(72) Inventors: Shogo MAKINO, Kitakyushu-shi (JP); Motomichi OHTO, Kitakyushu-shi (JP)

(73) Assignee: KABUSHIKI KAISHA YASKAWA DENKI, Kitakyushu-shi (JP)

(21) Appl. No.: 14/856,564

(22) Filed: Sep. 17, 2015

(30) Foreign Application Priority Data
Sep. 18, 2014 (JP) 2014-190583

(51) Int. Cl. H02K 41/03; H02K 1/27

(52) U.S. Cl. CPC H02K 41/031; H02K 1/27

(57) ABSTRACT

A linear-rotary actuator includes a rotor and a stator. The rotor includes an output shaft, and makes a linear motion in an axial direction of the output shaft and a rotary motion in a circumferential direction of the output shaft. The rotor includes permanent magnets and yokes alternating with each other in the axial direction. Each yoke includes protrusions that protrude toward an outer circumferential side of a radial direction of the output shaft and that are arranged in the circumferential direction. Each protrusion includes overhangs respectively extending toward first and second sides of the axial direction to overlap the permanent magnets in the radial direction. The stator includes a linear motion winding to generate a first magnetic field to cause the rotor to make the linear motion, and a rotary motion winding to generate a second magnetic field to cause the rotor to make the rotary motion.

### CROSS-REFERENCE TO RELATED APPLICATIONS

The present application claims priority under 35 U.S.C. §119 to Japanese Patent Application No. 2014-190583, filed Sep. 18, 2014. The contents of this application are incorporated herein by reference in their entirety.

### BACKGROUND

1. Field of the Invention

The embodiments disclosed herein relate to a linear-rotary actuator.

2. Discussion of the Background

Japanese Patent No. 5261913 discloses a linear-rotary actuator that makes linear and rotary motions.

“Design of Two-Degree-of-Freedom Electromagnetic Actuator using PMSM and LSM” (Mori Masaki. Wataru Kitagawa. and Takaharu Takeshita. Journal of the Japan Society of Applied Electromagnetics and Mechanics, September 2013, volume 21, no. 3, pp. 476-481) discloses a rotor including a plurality of permanent magnets and a plurality of yokes. The permanent magnets and the yokes are alternately arranged in an axial direction of the rotor. Each of the yokes has protrusions protruding in a radial direction of the yoke.

### SUMMARY

According to one aspect of the present disclosure, a linear-rotary actuator includes a rotor and a stator. The rotor includes an output shaft, and is configured to make a linear motion in an axial direction of the output shaft and make a rotary motion in a circumferential direction of the output shaft. The rotor includes a plurality of permanent magnets and a plurality of yokes. The plurality of yokes alternate with the plurality of permanent magnets in the axial direction. Each of the plurality of yokes includes a plurality of protrusions that protrude toward an outer circumferential side of a radial direction of the output shaft and that are arranged in the circumferential direction. Each of the protrusions includes overhangs respectively extending toward a first side and a second side of the axial direction to overlap the plurality of permanent magnets in the radial direction. The stator includes a linear motion winding and a rotary motion winding. The linear motion winding generates a first magnetic field to cause the rotor to make the linear motion. The rotary motion winding generates a second magnetic field to cause the rotor to make the rotary motion.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a cross-sectional view of a linear-rotary actuator according to an embodiment;

FIG. 2 is an enlarged view of essential parts of the linear-rotary actuator illustrated in FIG. 1;

FIG. 3 is a cross-sectional view of a rotor and a stator;

FIG. 4 is a perspective view of a core of the stator;

FIG. 5 is a perspective view of the rotor;

FIG. 6 is a side view of the rotor;

FIG. 7A is a cross-sectional view of the rotor;

FIG. 7B is a cross-sectional view of the rotor;

FIG. 8 is an enlarged view of the essential parts illustrated in FIG. 2;

FIG. 9 is a cross-sectional view of a linear-rotary actuator according to another embodiment;

FIG. 10 is a cross-sectional view of a rotor and a stator;

FIG. 11A is a cross-sectional view of the rotor;

FIG. 11B is a cross-sectional view of the rotor;

FIG. 12 is a cross-sectional view of a linear-rotary actuator according to another embodiment; and

FIG. 13 is a cross-sectional view of a linear-rotary actuator according to still another embodiment.

### DESCRIPTION OF THE EMBODIMENTS

The embodiments will now be described with reference to the accompanying drawings, wherein like reference numerals designate corresponding or identical elements throughout the various drawings.

### First Embodiment

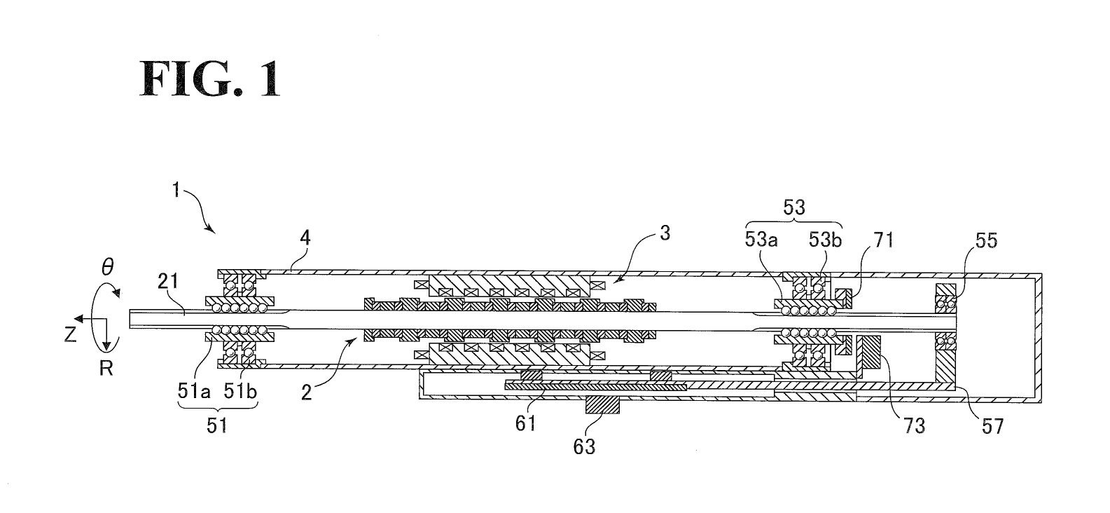

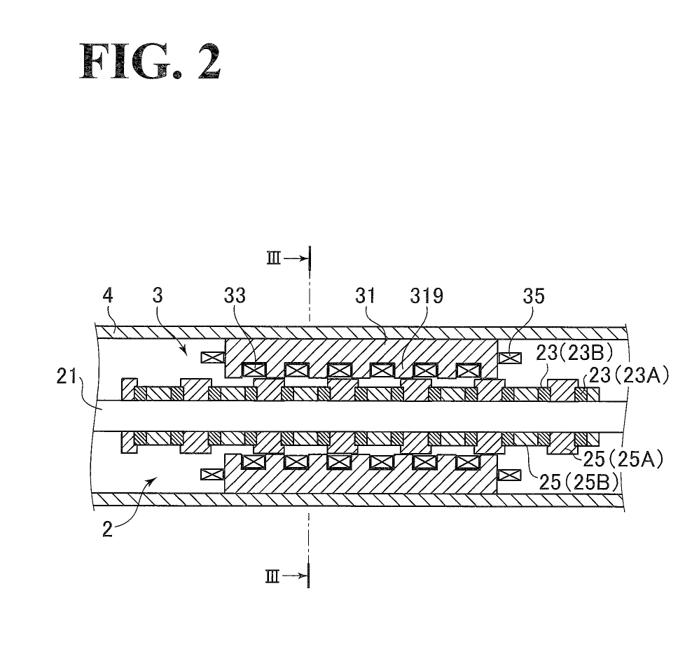

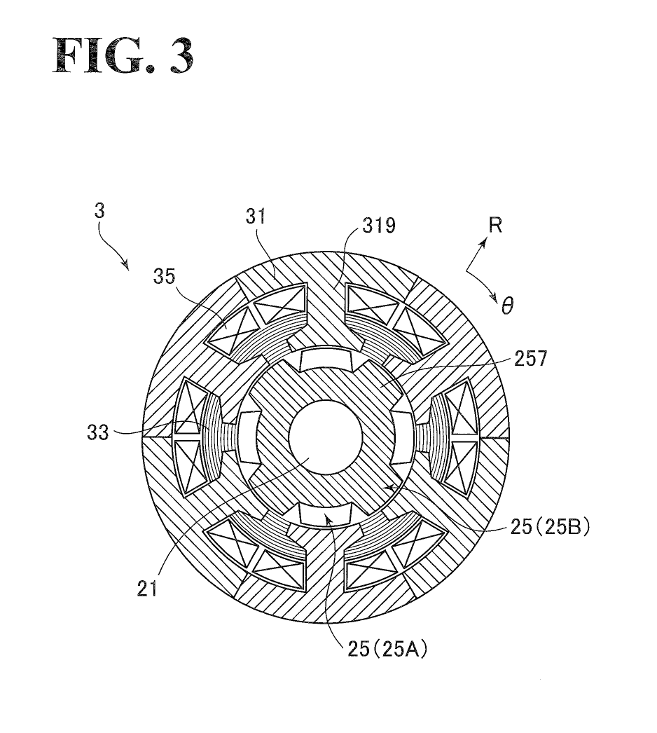

FIG. 1 is a cross-sectional view of a linear-rotary actuator 1 according to a first embodiment, taken along the axis of an output shaft 21. FIG. 2 is an enlarged view of essential parts, including a rotor 2 and a stator 3, of the linear-rotary actuator 1 illustrated in FIG. 1. FIG. 3 is a cross-sectional view of the rotor 2 and the stator 3, taken along the line of FIG. 2. In FIGS. 1 through 3, direction Z is the axial direction of the output shaft 21 and is a direction in which the rotor 2 moves linearly. Direction θ is the circumferential direction of the output shaft 21 and is a direction in which the rotor 2 rotates. Direction R is the radial direction of the output shaft 21.

As illustrated in FIG. 1, the linear-rotary actuator 1 includes the rotor 2 and the stator 3. The rotor 2 and the stator 3 are accommodated in a cylindrical housing 4. The rotor 2 includes the output shaft 21 and is supported by bearing units 51 and 53 to make a linear motion in direction Z and a rotary motion in direction θ relative to the housing 4. The bearing units 51 and 53 respectively include ball splines 51a and 53a and bearings 51b and 53b. A preferable example of the material of the output shaft 21 is a non-magnetic material. It is also possible, however, to use a ferromagnetic material. The stator 3 is secured on the inner circumferential surface of the housing 4, and surrounds the rotor 2.

One end of the output shaft 21 extends out of the housing 4. An arm 57 is attached to another end of the output shaft 21 through a bearing 55 and extends in direction Z. A linear scale 61 is attached to the arm 57. Together with a linear sensor 63, the linear scale 61 is used to detect the position of the output shaft 21 in direction Z. A disk-shaped permanent magnet 71 is attached to the ball spline 53a. The permanent magnet 71 and a magnetic detection element 73 constitute the magnetic encoder to detect the rotation angle of the output shaft 21 in direction θ. An optical rotary encoder may also be used.

As illustrated in FIGS. 2 and 3, the rotor 2 includes a plurality of permanent magnets 23 and a plurality of yokes 25. The permanent magnets 23 and the yokes 25 alternate with each other in direction Z. The permanent magnets 23 and the yokes 25 have annular shapes and are fitted around the output shaft 21. The permanent magnets 23 and the yokes 25 are in contact with each other and secured on the output shaft 21. A specific configuration of the rotor 2 will be described later.

The stator 3 includes linear motion windings 33 and rotary motion windings 35, which are wound around cores 31. The linear motion windings 33 and the rotary motion windings 35 are arranged concentrically around the output shaft 21 and overlap each other in direction R. The linear motion windings 33 are wound in direction θ to surround the rotor 2. Upon supply of current, the linear motion windings 33 generate a magnetic field to cause the rotor 2 to make a linear motion. The rotary motion windings 35 are wound in direction Z. Upon supply of current, the rotary motion windings 35 generate a magnetic field to cause the rotor 2 to make a rotary motion.

The stator 3 includes a plurality of cores 31 arranged in direction θ. The plurality of cores 31 constitute a cylindrical assembly surrounding the rotor 2. Each of the cores 31 includes a plurality of protruding cores 319, which protrude toward the inner circumferential side of direction R to be opposed to the rotor 2. The protruding cores 319 are also referred to as teeth. The protruding cores 319 are arranged in direction Z and in direction θ. In the example illustrated in FIGS. 2 and 3, seven protruding cores 319 are arranged in direction Z, and six protruding cores 319 are arranged in direction θ.

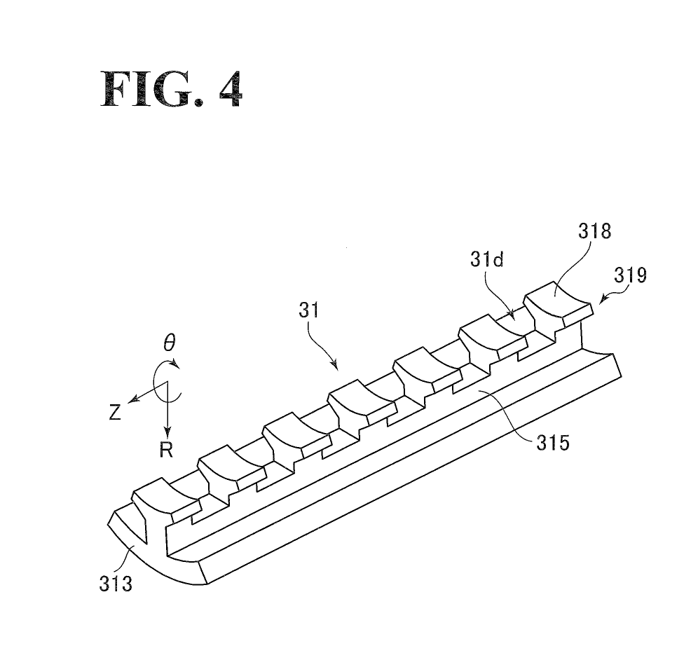

A specific configuration of the stator 3 is illustrated in FIG. 4. The stator 3 includes a wall 313, a rib 315, and the plurality of protruding cores 319. The wall 313 is curved along the inner circumferential surface of the housing 4. The rib 315 protrudes from the center of the wall 313 in direction θ toward the inner circumferential side of direction R. The plurality of protruding cores 319 protrude from the rib 315 toward the inner circumferential side of direction R. Each of the protruding cores 319 includes a distal end portion 318. The distal end portion 318 expands in direction θ.

The rotary motion winding 35 is repeatedly wound in direction Z to surround the rib 315. With the rotary motion windings 35 wound around the ribs 315, the cores 31 are accommodated in the housing 4 and assembled into a cylindrical shape. Each linear motion winding 33 is wound in direction θ across the plurality of cores 31, which are assembled in the cylindrical shape, in such a manner that the linear motion winding 33 is accommodated in a groove 31d between the protruding cores 319 adjacent to each other in direction Z.

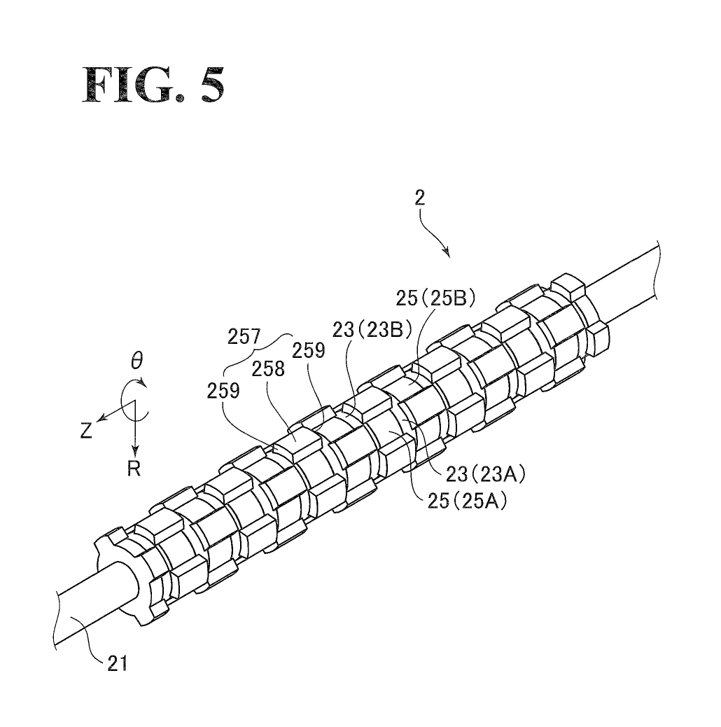

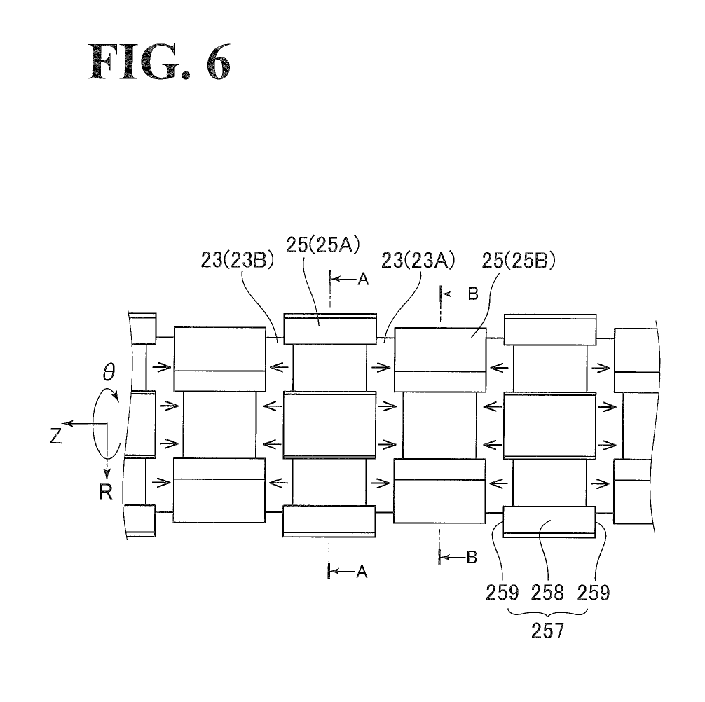

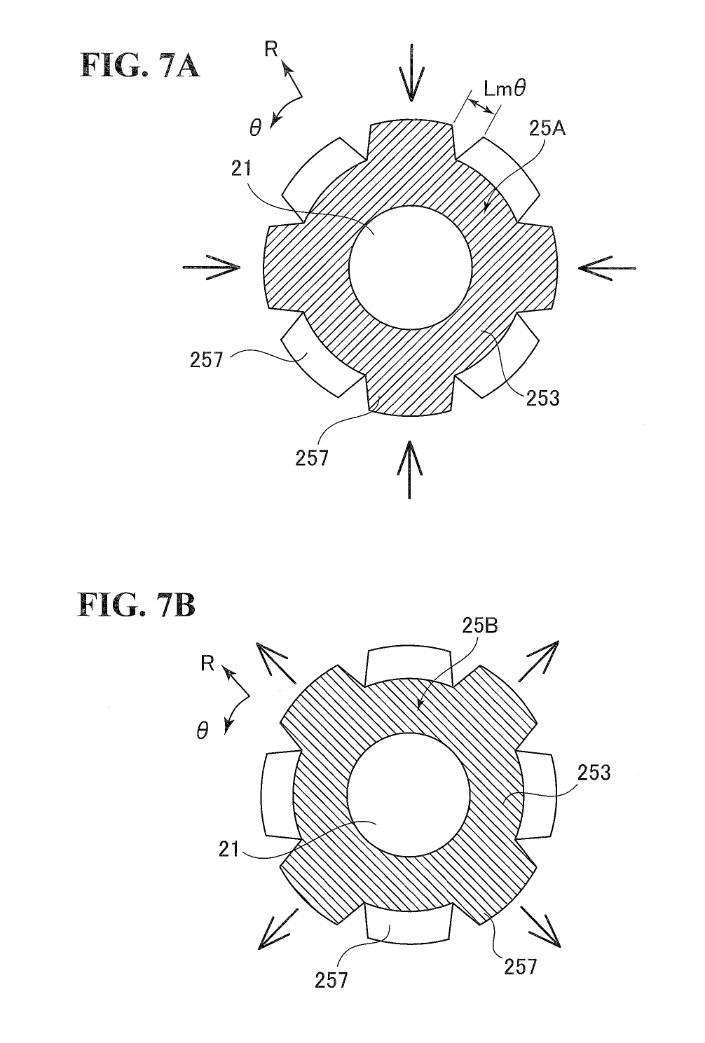

FIGS. 5 and 6 are respectively a perspective view and a side view of the rotor 2. In FIG. 6, the arrows on the permanent magnets 23 indicate directions of magnetization from the S pole to the N pole. FIG. 7A is a cross-sectional view of the rotor 2 taken along the line A-A of FIG. 6. FIG. 7B is a cross-sectional view of the rotor 2 taken along the line B-B of FIG. 6. In FIGS. 7A and 7B, the arrows around protrusions 257 of the yokes 25 indicate directions of magnetization from the N pole to the S pole.

The rotor 2 includes the plurality of permanent magnets 23 and the plurality of yokes 25. The plurality of permanent magnets 23 alternate with the plurality of yokes 25 in direction Z. The plurality of permanent magnets 23 include permanent magnets 23A and permanent magnets 23B. The permanent magnet 23A has its N pole on one side of direction Z. The permanent magnet 23B has its N pole on the other side of direction Z. The permanent magnet 23A and the permanent magnet 23B alternate with each other in direction Z. The plurality of yokes 25 include yokes 25A and yokes 25B. The yoke 25A is interposed between the S poles of the permanent magnets 23. The yoke 25B is interposed between the N poles of the permanent magnets 23. The yoke 25A and the yoke 25B alternate with each other in direction Z.

Each of the yokes 25 includes a plurality of protrusions 257. The protrusions 257 protrude from an annular portion 253 toward the outer circumferential side of direction R and are arranged in direction θ. The protrusions 257 are also referred to as teeth. The protrusions 257 of the yoke 25A, which is interposed between the S poles of the permanent magnets 23, are the S pole portions, while the protrusions 257 of the yoke 25B, which is interposed between the N poles of the permanent magnets 23, are the N pole portions. In other words, the protrusions 257 of the yokes 25A have their S pole on the outer circumferential side in direction R, while the protrusions 257 of the yokes 25B have their N pole on the outer circumferential side in direction R.

As seen in direction Z, the protrusions 257 (S pole portions) of the yokes 25A and the protrusions 257 (N pole portions) of the yokes 25B alternate with each other in direction θ. In the example illustrated in FIGS. 5 to 7A, each of the yokes 25A and 25B includes four protrusions 257 at intervals of 90 degrees. As seen in direction Z, eight protrusions 257 are arranged in direction θ at intervals of 45 degrees. As seen in direction θ, the protrusions 257 (S pole portions) of the yokes 25A and the protrusions 257 (N pole portions) of the yokes 25B alternate with each other in direction Z.

In the configuration in which the permanent magnets 23 alternate with the yokes 25 in direction Z, the two yokes 25A and 25B are separate from each other by the thickness of the permanent magnet 23 in direction Z. This separate configuration causes a tendency toward greater intervals between the protrusions in direction Z, as in “Design of Two-Degree-of-Freedom Electromagnetic Actuator using PMSM and LSM”. Greater intervals of the protrusions in direction Z, as in “Design of Two-Degree-of-Freedom Electromagnetic Actuator using PMSM and LSM”, can cause difficulty in obtaining a sufficient amount of output, and increase the size of the rotor in the axial direction.

In view of this, in this embodiment, each protrusion 257 of each yoke 25 are provided with overhangs 259 extending in direction Z.

Specifically, the protrusion 257 of each yoke 25 includes a central portion 258 and the overhangs 259. The central portion 258 continues from the annular portion 253 in direction R. The overhangs 259 extend from the central portion 258 respectively toward both sides of direction Z. The thickness of the overhang 259 in direction R and the width of the overhang 259 in direction θ are respectively the same as the thickness in direction R and the width in direction θ of the central portion 258. The overhangs 259, which extend from the central portion 258 in direction Z, overlap the permanent magnets 23 in direction R. The permanent magnet 23 has the same diameter as the annular portion 253 of the yoke 25. The outer circumferential surface of the permanent magnet 23 is fitted on the inner circumferential surface of the overhang 259.

Providing the protrusions 257 of the yokes 25 with the overhangs 259 ensures that the interval between the protrusions 257 of the two yokes 25A and 25B in direction Z is smaller than the thickness of the permanent magnet 23 in direction Z is. This configuration increases the output of the rotor 2 and reduces the dimension of the rotor 2 in direction Z.

Specifically, the reduced interval between the protrusion 257 (S pole portion) of the yoke 25A and the protrusion 257 (N pole portion) of the yoke 25B in direction Z increases the magnet flux density of the rotor 2, thereby improving both of the linear output and the rotary output of the rotor 2. In particular, it is in direction Z that the magnetic flux density of the rotor 2 is increased. This configuration facilitates the improvement of the linear output of the rotor 2. Moreover, while the required length of the protrusion 257 in direction Z is secured, the length of the annular portion 253 in direction Z is decreased. As a result, the dimension of the whole apparatus in direction Z is reduced.

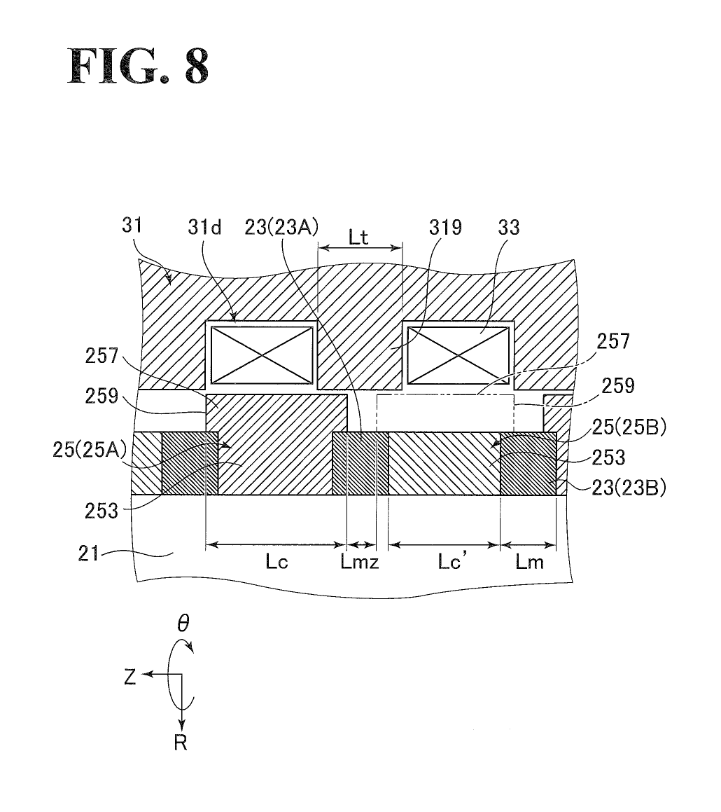

FIG. 8 is an enlarged view of the essential parts, including the permanent magnets 23A and 23B, the yokes 25A and 25B, and the protruding cores 319, illustrated in FIG. 2. In FIG. 8, the protrusion 257 (N pole portion) of the yoke 25B, which is not shown in the cross-section, is indicated by a phantom line.

Dimension Lc is the length of the protrusion 257 including the overhangs 259 in direction Z. Dimension Lc′ is the length of the annular portion 253 in direction Z, that is, a difference obtained by subtracting the lengths of the overhangs 259 from the length Lc of the protrusion 257 in direction Z. Dimension Lm is the thickness of the permanent magnet 23 in direction Z, that is, an interval between the two adjacent annular portions 253 in direction Z. Dimension Lmz is the interval as seen in direction θ between the protrusion 257 (S pole portion) of the yoke 25A and the protrusion 257 (N pole portion) of the yoke 25B in direction Z. Dimension Lt is the length of the protruding core 319 in direction Z, which is formed on the core 31 of the stator 3. Specifically, dimension Lt is the length, in direction Z, of the surface of the protruding core 319 that is opposed to the rotor 2.

The protrusion 257 (S pole portion) of the yoke 25A and the protrusion 257 (N pole portion) of the yoke 25B preferably do not overlap each other in the circumferential direction. That is, the interval Lmz between the two protrusions 257 is preferably larger than 0. The lengths of the overhangs 259 (that is, Lc−Lc′) are preferably smaller than half the thickness Lm of the permanent magnet 23. Thus, the S pole portions and the N pole portions do not overlap each other in the circumferential direction. This configuration eliminates or minimizes a leakage of flux and increases the linear output of the rotor 2.

Furthermore, the interval Lmz as seen in direction θ between the protrusion 257 (S pole portion) of the yoke 25A and the protrusion 257 (N pole portion) of the yoke 25B in direction Z is preferably larger than the interval Lmθ as seen in direction Z (see FIG. 7A) between these two protrusions 257 in direction θ. Securing the interval Lmz between the S pole portion and the N pole portion eliminates or minimizes a leakage of flux and increases the linear output of the rotor 2.

The length Lc of the protrusion 257 in direction Z is preferably larger than the length Lt of the protruding core 319 in direction Z. This configuration makes induction voltage generated on the linear motion windings 33 closer to a sinusoidal wave, and increases the linear output of the rotor 2.

Specifically, when the protrusions 257 move in direction Z, the density of the magnetic flux on the protruding cores 319 gradually increases as the protrusions 257 approach the protruding cores 319. The density of the magnetic flux on the protruding cores 319 gradually decreases as the protrusions 257 move away from the protruding cores 319. This configuration makes the induction voltage generated on the linear motion windings 33 closer to a sinusoidal wave. Generally, the magnetic flux density on the rotor 2 side is larger than the magnetic flux density on the stator 3 side. In view of this, making the length Lc of the protrusion 257 in direction Z larger than the length Lt of the protruding core 319 in direction Z facilitates the attempt to make the induction voltage generated on the linear motion windings 33 closer to a sinusoidal wave.

### Second Embodiment

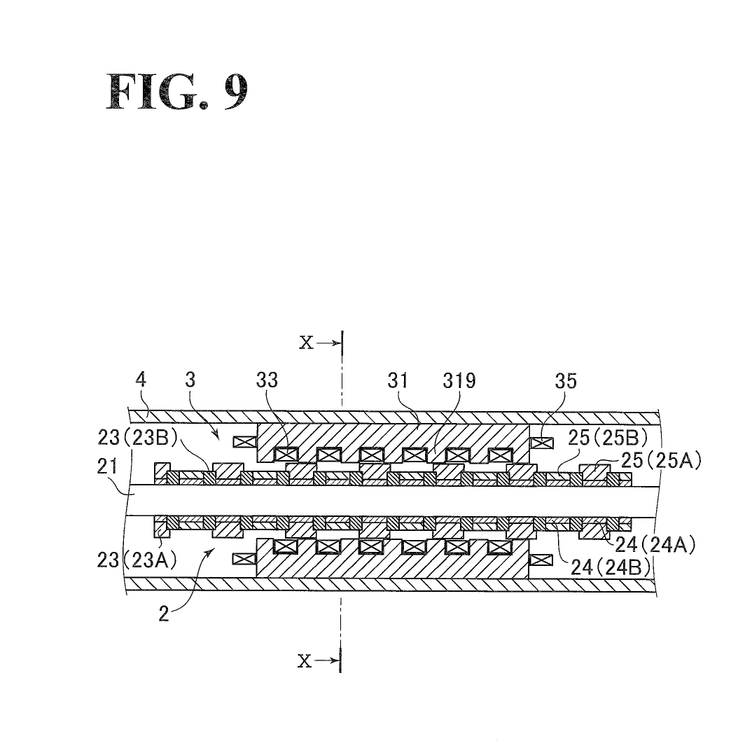

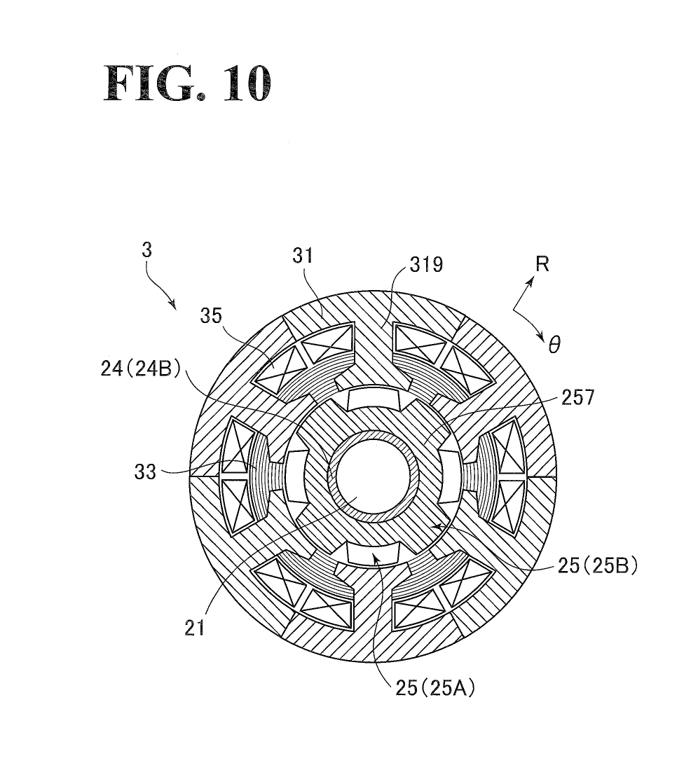

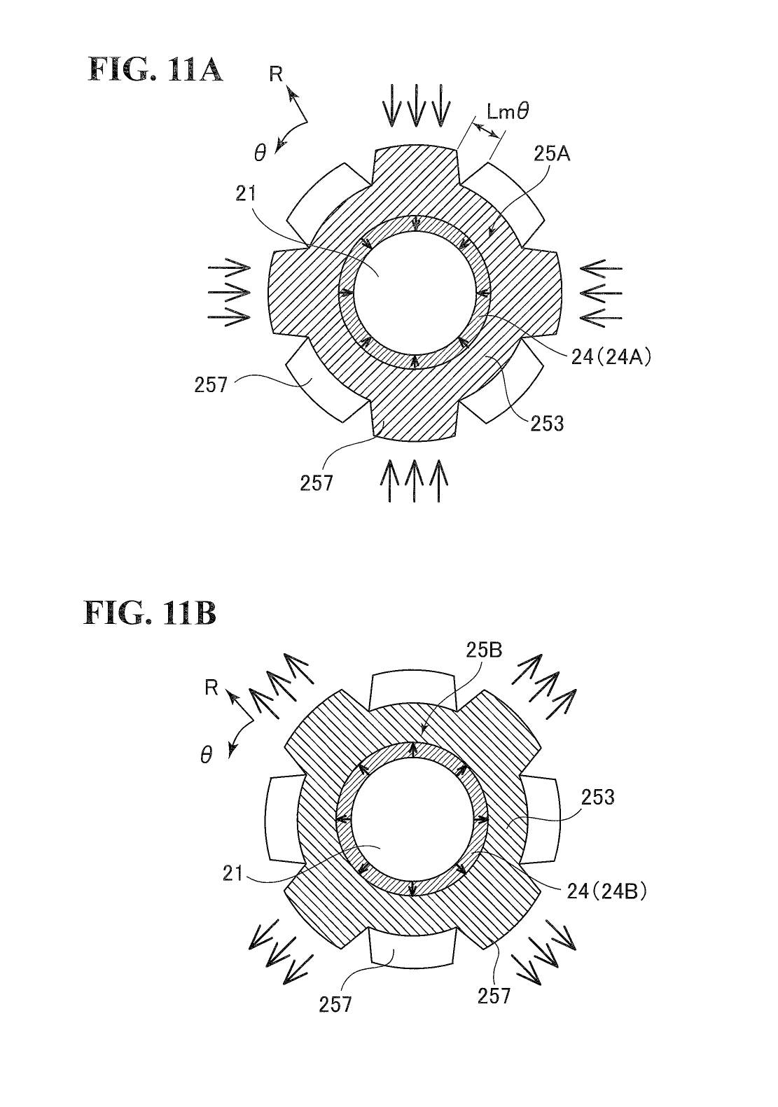

FIG. 9 is an enlarged cross-sectional view of essential parts, including a rotor 2 and a stator 3, of a linear-rotary actuator 1 according to a second embodiment. FIG. 10 is a cross-sectional view of the rotor 2 and the stator 3 taken along the line X-X of FIG. 9. FIGS. 11A and 11B are cross-sectional views respectively corresponding to FIGS. 7A and 7B. Like reference numerals designate corresponding or identical elements throughout this and above embodiments, and these elements will not be elaborated here.

In the second embodiment, permanent magnets 24 are disposed on the inner circumferential side of the yokes 25 in direction R. Specifically, the permanent magnets 24 have annular shapes interposed between the yokes 25 and the output shaft 21. More specifically, a permanent magnet 24A is disposed on the inner circumferential side of the yoke 25A in direction R. The yoke 25A is interposed between the S poles of the permanent magnets 23. The permanent magnet 24A has its S pole on the outer circumferential side in direction R. A permanent magnet 24B is disposed on the inner circumferential side of the yoke 25B in direction R. The yoke 25B is interposed between the N poles of the permanent magnets 23. The permanent magnet 24B has its N pole on the outer circumferential side in direction R.

This configuration further improves the magnetic flux density on the protrusions 257 of the yokes 25, resulting in further improvement in the linear output and the rotary output of the rotor 2. Specifically, arranging the permanent magnets 24A on the inner circumferential side of the yokes 25A in direction R further improves the density of the magnetic flux flowing to the protrusions 257 (S pole portions) of the yokes 25A. Arranging the permanent magnets 24B on the inner circumferential side of the yokes 25B in direction R further improves the density of the magnetic flux flowing out of the protrusions 257 (N pole portions) of the yokes 25B.

### Third Embodiment

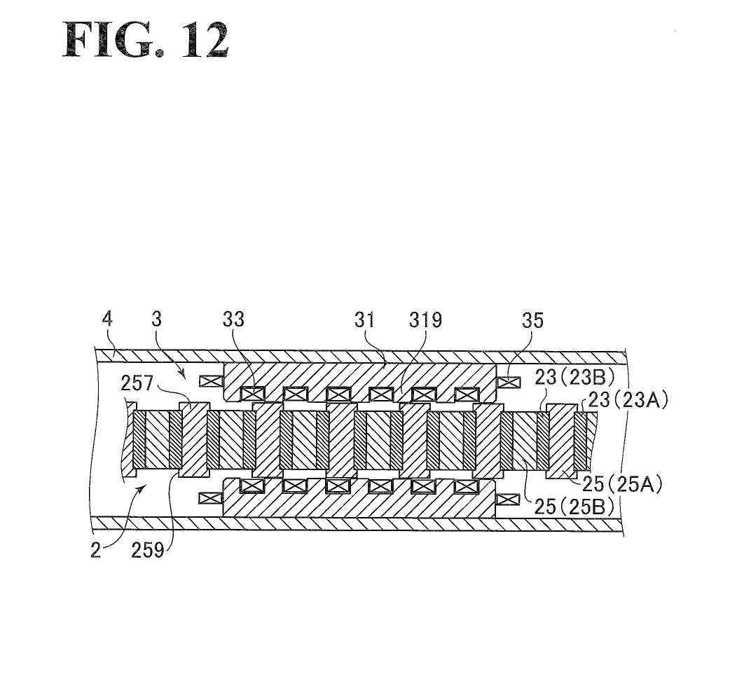

FIG. 12 is an enlarged cross-sectional view of essential parts, including a rotor 2 and a stator 3, of a linear-rotary actuator 1 according to a third embodiment. Like reference numerals designate corresponding or identical elements throughout this and above embodiments, and these elements will not be elaborated here.

In the third embodiment, the permanent magnets 23 and the yokes 25 have disk shapes. The permanent magnets 23 and the yokes 25 are adhered to each other and aligned in the axial direction to constitute the rotor 2. That is, in this embodiment, the output shaft 21 (see FIG. 2, for example) is omitted over the range in which the permanent magnets 23 and the yokes 25 are provided. No through holes for the output shaft 21 are formed in the permanent magnets 23 nor in the yokes 25.

This configuration further improves the magnetic flux density on the protrusions 257 of the yokes 25, resulting in further improvement in the linear output and the rotary output of the rotor 2.

### Fourth Embodiment

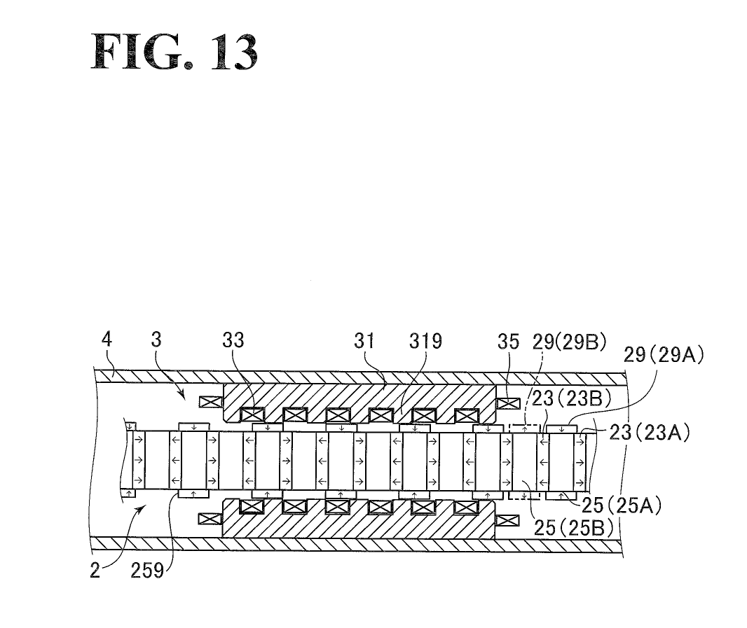

FIG. 13 is an enlarged cross-sectional view of essential parts, including a rotor 2 and a stator 3, of a linear-rotary actuator 1 according to a fourth embodiment. In FIG. 13, to indicate directions of magnetization, hatching otherwise necessary to indicate the cross-section of the rotor 2 is omitted. Like reference numerals designate corresponding or identical elements throughout this and above embodiments, and these elements will not be elaborated here.

The fourth embodiment is similar to the third embodiment in that the permanent magnets 23 and the yokes 25 have disk shapes. The permanent magnets 23 and the yokes 25 are adhered to each other and aligned in the axial direction to constitute the rotor 2.

Also in this embodiment, instead of the protrusions 257 according to the first to third embodiments, protrusions 29 made of permanent magnet are adhered to the outer circumferential surfaces of the yokes 25. The positions, dimensions, and ranges related to the protrusions 29 are approximately the same as the positions, dimensions, and ranges related to the protrusions 257 according to the first to third embodiments (see FIGS. 5 to 8, for example).

Specifically, a protrusion 29A is adhered to the outer circumferential surface of the yoke 25A, which is interposed between the S poles of the permanent magnets 23. The outer circumferential side of the protrusion 29A in direction R is the S pole (S pole portion). A protrusion 29B is adhered to the outer circumferential surface of the yoke 25B, which is interposed between the N poles of the permanent magnets 23. The outer circumferential side of the protrusion 29B in direction R is the N pole (N pole portion). In FIG. 13, the protrusions 29B, which are not shown in cross-section, are indicated by a phantom line.

This configuration further improves the magnetic flux density in the protrusions 29, resulting in further improvement in the linear output and the rotary output of the rotor 2. Specifically, arranging the protrusions 29A on the outer circumferential surfaces of the yokes 25A further improves the density of the magnetic flux flowing to the protrusions 29A (S pole portions). Arranging the protrusions 29B on the outer circumferential surfaces of the yokes 25B further improves the density of the magnetic flux flowing out of the protrusions 29B (N pole portions).

Comparison with Japanese Patent No. 5261913

Japanese Patent No. 5261913, at the third embodiment and FIG. 5, discloses claw pole cores 263a and 263b. As apparent from the literal meaning of “claw pole”, claw portions protrude only to one side of the axial direction in which permanent magnets 253 are arranged. In this manner, the magnetic poles in the radial direction are formed in the claw portions. That is, Japanese Patent No. 5261913 nowhere discloses that each core is interposed between two permanent magnets in the axial direction, nor that the claw portions respectively protrude toward both sides of the axial direction.

In contrast, in the first to fourth embodiments, each yoke 25 is interposed between two permanent magnets 23A and 23B in direction Z. The protrusion 257 of the yoke 25A, which is interposed between the S poles of the permanent magnets 23, is the S pole portion. The protrusion 257 of the yoke 25B, which is interposed between the N poles of the permanent magnets 23, is the N pole portion. Each protrusion 257 of each yoke 25 has overhangs 259 protruding toward both sides of direction Z.

Thus, the first to fourth embodiments are clearly distinguished over Japanese Patent No. 5261913. Therefore, there should be no confusion between the yoke 25 including the overhangs 259 according to any of the first to fourth embodiments and the claw pole cores recited in Japanese Patent No. 5261913.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. A linear-rotary actuator comprising:
a rotor comprising an output shaft, the rotor being configured to make a linear motion in an axial direction of the output shaft and make a rotary motion in a circumferential direction of the output shaft, the rotor comprising:
a plurality of permanent magnets, and
a plurality of yokes alternating with the plurality of permanent magnets in the axial direction, each of the plurality of yokes comprising a plurality of protrusions that protrude toward an outer circumferential side of a radial direction of the output shaft and that are arranged in the circumferential direction, each of the protrusions comprising overhangs respectively extending toward a first side and a second side of the axial direction to overlap the plurality of permanent magnets in the radial direction; and
a stator comprising:
a linear motion winding to generate a first magnetic field to cause the rotor to make the linear motion; and
a rotary motion winding to generate a second magnetic field to cause the rotor to make the rotary motion.

2. The linear-rotary actuator according to claim 1, wherein the plurality of yokes comprise
a first yoke on one side of one permanent magnet among the plurality of permanent magnets in the axial direction, and
a second yoke on another side of the one permanent magnet in the axial direction,
wherein the overhangs of the protrusions of the first yoke are not overlapped in the circumferential direction with the overhangs of the protrusions of the second yoke.

3. The linear-rotary actuator according to claim 1, wherein an outer circumferential surface of one permanent magnet among the plurality of permanent magnets is fitted on an inner circumferential surface of one overhang among the overhangs.

4. The linear-rotary actuator according to claim 1, wherein the stator further comprises a plurality of protruding cores that protrude toward an inner circumferential side of the radial direction to be opposed to the rotor and that are arranged in the axial direction and in the circumferential direction.

5. The linear-rotary actuator according to claim 4, wherein each of the plurality of protrusions comprises a length in the axial direction, the length being larger than a length of each of the plurality of protruding cores in the axial direction.

6. The linear-rotary actuator according to claim 1, wherein the plurality of yokes comprise
a first yoke on one side of one permanent magnet among the plurality of permanent magnets in the axial direction, and
a second yoke on another side of the one permanent magnet in the axial direction,
wherein an axial distance, as seen in the circumferential direction, from each of the protrusions of the first yoke to each of the protrusions of the second yoke is larger than a circumferential distance, as seen in the axial direction, from each of the protrusions of the first yoke to each of the protrusions of the second yoke.

7. The linear-rotary actuator according to claim 1, wherein the rotor further comprises a permanent magnet on an inner circumferential side, in the radial direction, of each of the plurality of yokes.

8. The linear-rotary actuator according to claim 1, wherein the plurality of permanent magnets and the plurality of yokes have disk shapes adhered to each other and aligned in the axial direction.

9. The linear-rotary actuator according to claim 1, wherein the plurality of protrusions each comprise a permanent magnet adhered to an outer circumferential surface of a corresponding yoke among the plurality of yokes.
